(19) United States
(12) Patent Application Publication
(10) Pub. No.: US 2018/0112678 A1
(43) Pub. Date: Apr. 26, 2018

(54) AIR PURIFIER AND WIND TUNNEL THEREOF

(71) Applicants: Beijing Xiaomi Mobile Software Co., Ltd., Beijing (CN); Beijing Smartmi Technology Co., Ltd., Beijing (CN)

(72) Inventors: Jun SU, Beijing (CN); Yi WANG, Beijing (CN); Zhuoli YU, Beijing (CN)

(21) Appl. No.: 15/598,325

(22) Filed: May 18, 2017

(30) Foreign Application Priority Data
Oct. 24, 2016 (CN) 201610939658.8

(51) Int. Cl. F04D 29/44; F04D 17/02; F04D 29/42; F04D 29/52

(52) U.S. Cl. CPC F04D 29/441; F04D 17/025; B01D 45/08; F04D 29/522; F04D 29/4253

(57) ABSTRACT

Disclosed is an air purifier and a wind tunnel thereof. The wind tunnel includes: a wind inlet; a wind outlet; a turbo fan arranged at the wind inlet for sucking into an air flow and blowing the air flow towards the wind outlet along an inner wall of the wind tunnel; an axial fan arranged at the wind outlet for discharging the air flow; and a flow-spoiler portion formed on the inner wall of the wind tunnel between the turbo fan and the axial fan, wherein the flow-spoiler portion spoils the air flow to make at least a portion of the air flow to be away from the inner wall of the wind tunnel when it is blown towards the axial fan.

### CROSS-REFERENCE TO RELATED APPLICATIONS

This application is filed based upon and claims priority to Chinese Patent Application No. 201610939658.8, filed to Chinese Patent Office on Oct. 24, 2016, the entire contents of which are incorporated herein by reference.

### TECHNICAL FIELD

The present disclosure generally relates to air purifier techniques, and more particularly to an air purifier and a wind tunnel thereof.

### BACKGROUND

An air purifier can purify surrounding air to effectively improve indoor air quality. The air purifier may include a purifier and a wind tunnel. The purifier may filter out particles and germs in the air by filter element filtering, high voltage electrostatic adsorption, biodegradation and the like. The wind tunnel may cause air to flow, such that the surrounding air is drawn into the purifier and the purified air is released.

Typically, the wind tunnel typically has a cylinder structure. A turbo fan and an axial fan are arranged respectively at a wind inlet and a wind outlet of the wind tunnel. The turbo fan circumferentially blows the purified air to generate an air flow which may rise spirally along an inner wall of the wind tunnel and then may be upwardly and axially accelerated by the axial fan.

However, since air flow generated by the turbo fan is blown towards the axial fan along the inner wall of the wind tunnel, the air flow can be accelerated by merely peripheral portions of blades of the axial fan, which not only wastes resources of the axial fan but also influences the overall purifying effectiveness of the air purifier.

### SUMMARY

According to a first aspect of embodiments of the present disclosure, there is provided a wind tunnel for an air purifier. The wind tunnel includes: a wind inlet; a wind outlet; a turbo fan arranged at the wind inlet for sucking into an air flow and blowing the air flow towards the wind outlet along an inner wall of the wind tunnel; an axial fan arranged at the wind outlet for discharging the air flow; and a flow-spoiler portion formed on the inner wall of the wind tunnel between the turbo fan and the axial fan, wherein the flow-spoiler portion spoils the air flow to make at least a portion of the air flow to be away from the inner wall of the wind tunnel when it is blown towards the axial fan.

According to a second aspect of embodiments of the present disclosure, there is provided an air purifier. The air purifier includes a wind tunnel and the wind tunnel includes: a wind inlet; a wind outlet; a turbo fan arranged at the wind inlet for sucking into an air flow and blowing the air flow towards the wind outlet along an inner wall of the wind tunnel; an axial fan arranged at the wind outlet for discharging the air flow; and a flow-spoiler portion formed on the inner wall of the wind tunnel between the turbo fan and the axial fan, wherein the flow-spoiler portion spoils the air flow to make at least a portion of the air flow to be away from the inner wall of the wind tunnel when it is blown towards the axial fan.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of a typical wind tunnel for an air purifier;

FIG. 2 is a schematic diagram of a wind tunnel for an air purifier according to an exemplary embodiment;

FIG. 3 is a schematic diagram of specification of a wind tunnel for an air purifier according to an exemplary embodiment;

FIG. 4 is a top view of a wind tunnel for an air purifier according to an exemplary embodiment;

FIG. 5 is a top view of another wind tunnel for an air purifier according to an exemplary embodiment;

FIG. 6 is a schematic diagram of a wind tunnel for an air purifier according to an exemplary embodiment;

FIG. 7 is a schematic diagram of air-flow spoiling of the wind tunnel shown in FIG. 6;

FIG. 8 is a schematic diagram of another wind tunnel for an air purifier according to an exemplary embodiment;

FIG. 9 is a schematic diagram of air-flow spoiling of the wind tunnel shown in FIG. 8;

FIG. 10 is a schematic diagram of yet another wind tunnel for an air purifier according to some embodiments;

FIG. 11 is a schematic diagram of air-flow spoiling of the wind tunnel shown in FIG. 10;

FIG. 12 is a schematic diagram of a wind tunnel for an air purifier according to some embodiments;

FIG. 13 is a schematic diagram of air-flow spoiling of the wind tunnel shown in FIG. 12;

FIG. 14 is a schematic diagram of a wind tunnel for another air purifier according to the second exemplary embodiment;

FIG. 15 is a schematic diagram of air-flow spoiling of the wind tunnel shown in FIG. 14; and

FIG. 16 is a schematic diagram of a wind tunnel for yet another air purifier according to some embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

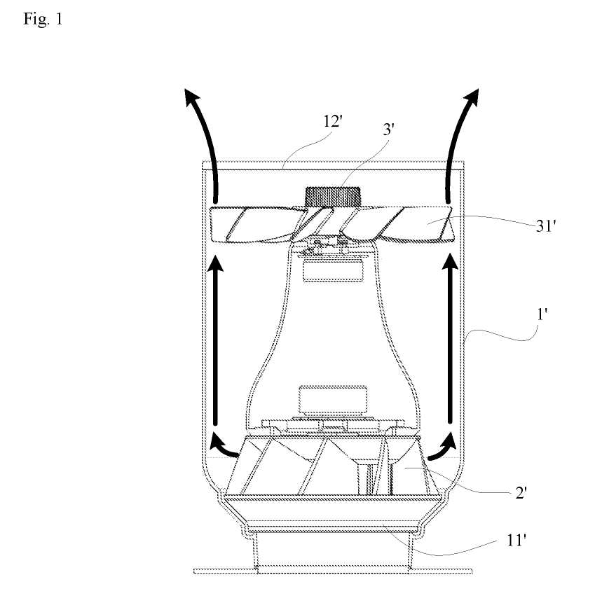

FIG. 1 is a schematic diagram of a typical wind tunnel for an air purifier. As shown in FIG. 1, a purifier of the air purifier is omitted in order to show and depict a wind tunnel 1′. The wind tunnel 1′ is substantially cylindrical. In the air purifier shown in FIG. 1, at bottom of the wind tunnel 1′, there is a wind inlet at which a turbo fan 2′ is arranged, and at top of the wind tunnel 1′, there is a wind outlet at which an axial fan 3′ is arranged. In operation, the turbo fan 2′ blows air flow towards an inner wall of the wind tunnel 1′, such that the air flow rises spirally along the inner wall of the wind tunnel 1′ and flow towards the axial fan 3′.

However, since the air flow rises substantially along the inner wall of the wind tunnel 1′, the air flow blown by the turbo fan 2′ is accelerated by merely the peripheral portions (i.e., the end portions) of blades 31′ of the axial fan 3′, and the acceleration on the air flow by middle areas or internal areas of the blades 31′ is very limited, which not only wastes rotation resources of the axial fan 3′ but also influences the overall purifying effectiveness of the air purifier.

Thus, embodiments of the present disclosure improve the wind tunnel 1′ for an air purifier, which will be illustrated below.

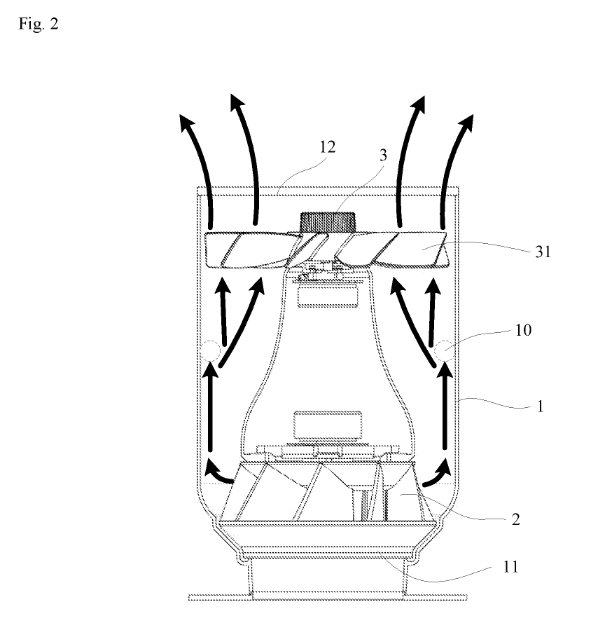

FIG. 2 is a schematic diagram of a wind tunnel for an air purifier according to an exemplary embodiment. As shown in FIG. 2, a wind tunnel 1 in the embodiment of the disclosure includes a turbo fan 2 arranged at a wind inlet 11 of the wind tunnel 1, and an axial fan 3 arranged at a wind outlet 12 of the wind tunnel 1. An air flow generated by the turbo fan 2 may be blown towards the axial fan 3 along an inner wall of the wind tunnel 1 and then released from the wind tunnel 1 via the axial fan 3. A flow-spoiler portion 10 is formed on the inner wall of the wind tunnel 1 between the turbo fan 2 and the axial fan 3. The flow-spoiler portion 10 spoils an air flow blown towards the axial fan 3 along the inner wall of the wind tunnel 1, so as to make at least a portion of the air flow, when blown towards the axial fan 3, to be away from the inner wall of the wind tunnel 1.

In this embodiment, the flow-spoiler portion 10 formed on an inner wall of the wind tunnel 1, spoils the air flow which may rise spirally along the inner wall of the wind tunnel 1, so as to make at least a portion of the air flow to be away from the inner wall of the wind tunnel 1. Therefore, this portion of the air flow, when going through the axial fan 3, may be more close to and accelerated by middle of blades 31 of the axial fan 3, and the remaining portion of the air flow may continue to rise along the inner wall of the wind tunnel 1 and may be accelerated by end portions of the blades 31, so as to make full use of the axial acceleration resources of the axial fan 3. Therefore, the wind tunnel has a greater amount of wind when the fan specification, a wind tunnel size, a filter element type and other conditions remain unchanged, which not only increases the coverage of the purified air, but also strengthens air convection so as to improve indoor air purifying effectiveness and save the power consumption of the air purifier.

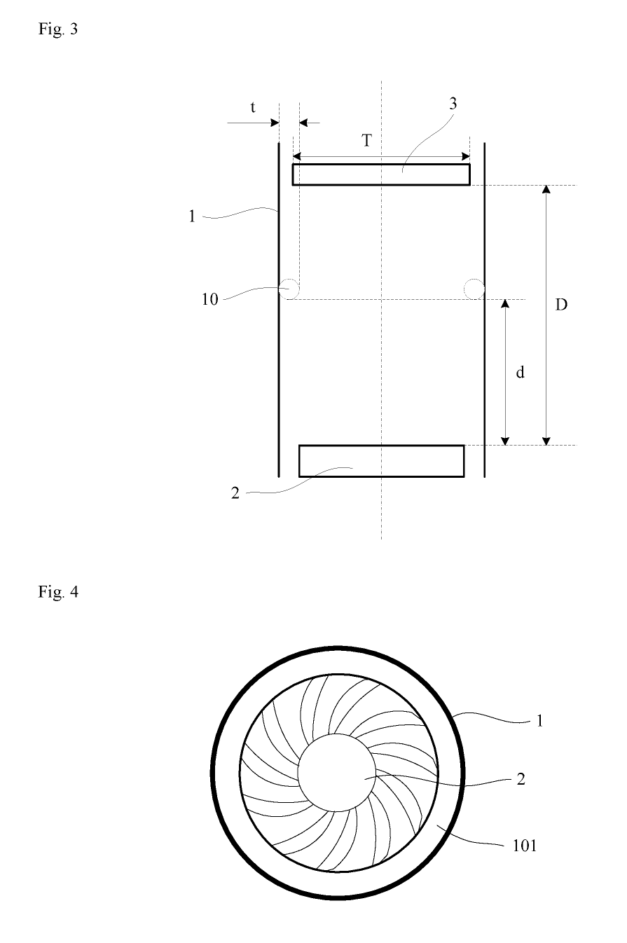

In this embodiment, when the wind inlet 11 is arranged at the bottom of the wind tunnel 1 and the wind outlet 12 is arranged at the top of the wind tunnel 1, the flow-spoiler portion 10 may be at a higher position than that of the turbo fan 2, such that the air flow, blown towards the axial fan 3 by the turbo fan 2, before being spoiled by the flow-spoiler portion 10, has flown at least a preset distance along the inner wall of the wind tunnel to reach a preset rate. Therefore, it can prevent the flow-spoiler portion 10 from causing the air flow to be slow, thereby decreasing the wind amount of the air purifier. For example, as shown in FIG. 3, when a distance between the turbo fan 2 and the axial fan 3 is D, a distance between a lowest point of the flow-spoiler portion and the turbo fan 2 may be d, and (⅓)D≤d≤(⅔)D. In an example, d≈(½)D. However, the disclosure is not intended to limit thereto.

According to the technical solutions of the embodiments of the disclosure, the flow-spoiler portion 10 may have a plurality of implementations. The implementations of the flow-spoiler portion 10 will be illustrated by way of examples.

According to an exemplary embodiment of the disclosure, the flow-spoiler portion 10 may include an inward convex portion formed on the inner wall of the wind tunnel 1. During the air flow generated by the turbo fan 2 rising spirally along the inner wall of the wind tunnel 1, the convex portion may, to a certain extent, block the air flow to disturb a flowing direction of the air flow and thus spoil the air flow, causing the air flow to be away from the inner wall of wind tunnel 1.

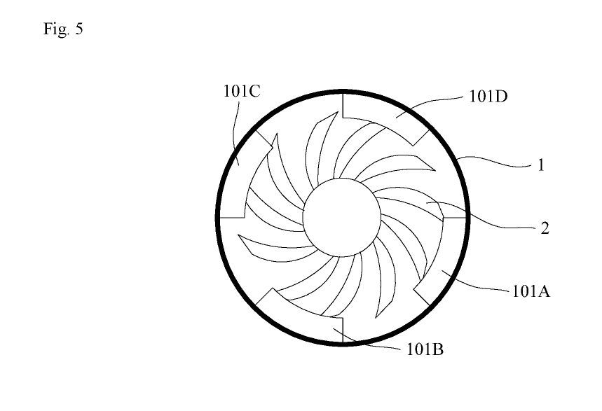

In one case, as shown in FIG. 4, when the flow-spoiler portion 10 includes a convex portion, the convex portion may have an integral hollow-ring structure 101. FIG. 4 schematically shows a top view of the hollow-ring structure 10 (in the case that the axial fan 3 at the wind outlet is removed).

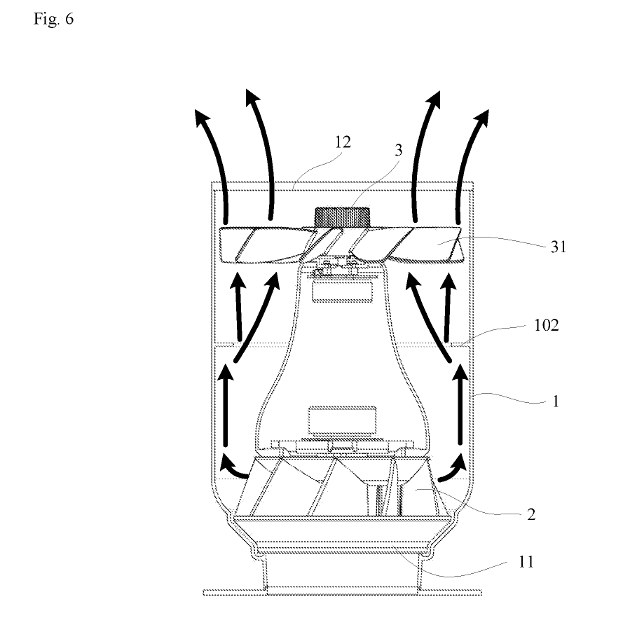

In another case, the flow-spoiler portion 10 may include a plurality of convex portions. As shown in FIG. 5, the flow-spoiler portion 10 may include a convex portion 101A, a convex portion 101B, a convex portion 101C and a convex portion 101D, which may be distributed on the inner wall of the wind tunnel 1 at intervals in a ring shape. Therefore, only areas with the convex portions can spoil the air flow, and areas without the convex portions can normally allow the air flow to pass, thus striking a balance between the air-flow spoiling and the air-flow flowing. The convex portions may be distributed uniformly at a same altitude on the inner wall of the wind tunnel 1 and thus may evenly spoil the air flow generated by the turbo fan 2, which helps the air purifier to release purified air evenly towards individual directions in a room, and avoids any purification “blind corner” or “weak point”.

Although the flow-spoiler portion 10 shown in FIG. 5 includes four convex portions, i.e., the convex portion 101A, the convex portion 101B, the convex portion 101C and the convex portion 101D in this exemplary embodiment, in fact, the number, the shapes and the arrangement of the convex portions included in the flow-spoiler portion 10 may vary depending on the conditions such as the size of the wind tunnel 1, specification of the turbo fan 2 and specification of the axial fan 3, which is not intended to limit.

For the above described flow-spoiler portion 10 including the hollow-ring structure or the plurality of convex portions, a convex portion included in the flow-spoiler portion 10 may have one of the following structures.

As an example, the convex portion may have a plate shape, and thus the flow-spoiler portion 10 may include a separation plate 102 as shown in FIG. 6. In the case of the hollow-ring structure 101 as shown in FIG. 4, the separation plate 102 may be a hollow-ring separation plate 102. In the case of the plurality of convex portions shown in FIG. 5, the flow-spoiler portion 10 may include a plurality of separation plates 102 arranged at intervals. It is to be noted that, although the separation plate 102 can spoil the air flow so as to make a portion of the air flow to be away from the inner wall of the wind tunnel 1 and blown towards middle of the blades 31 of the axial fan 3, the separation plate 102, due to having a plane towards the turbo fan 2, has a direct blocking effect on the air flow, causing that the flowing rate of the air flow may be influenced to a certain extent, e.g., the air flow may be slowed to a certain extent.

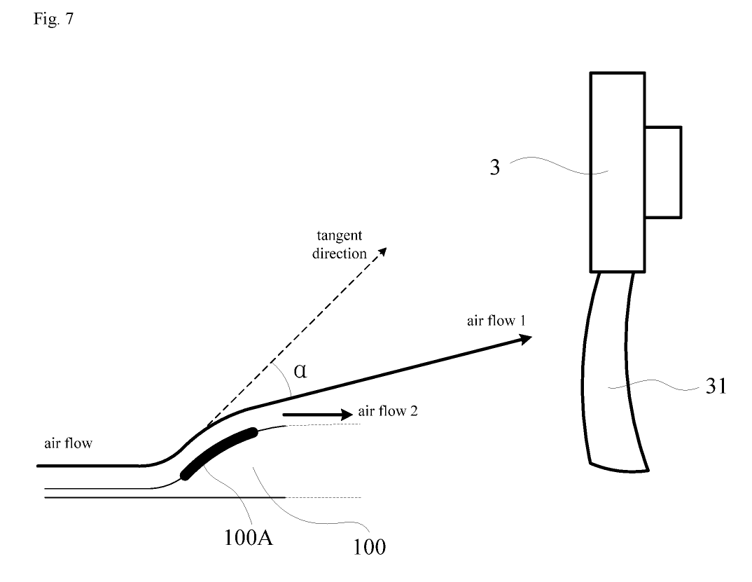

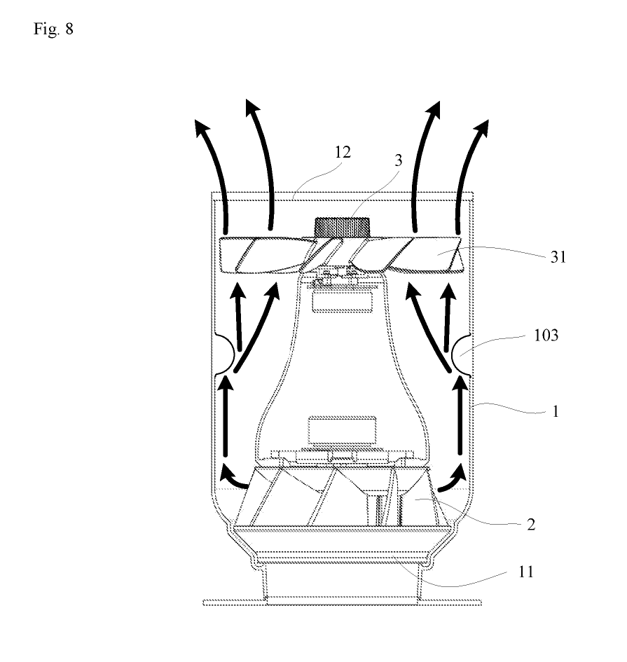

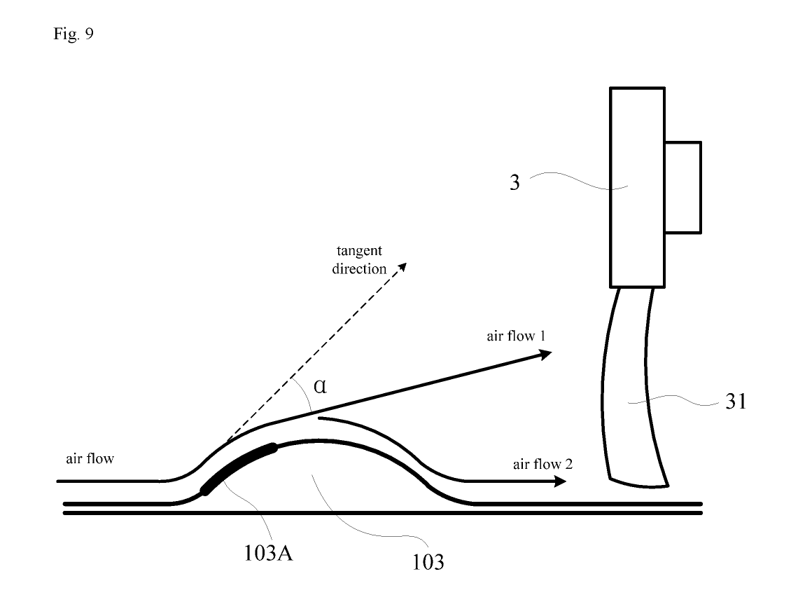

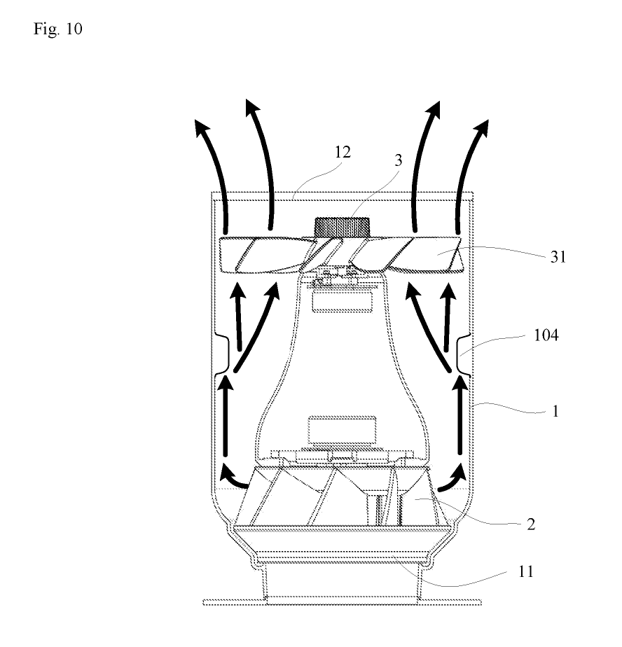

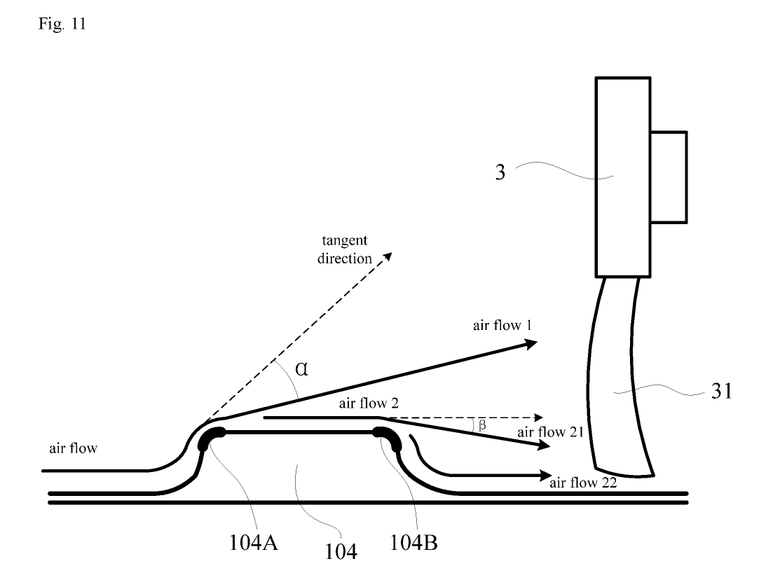

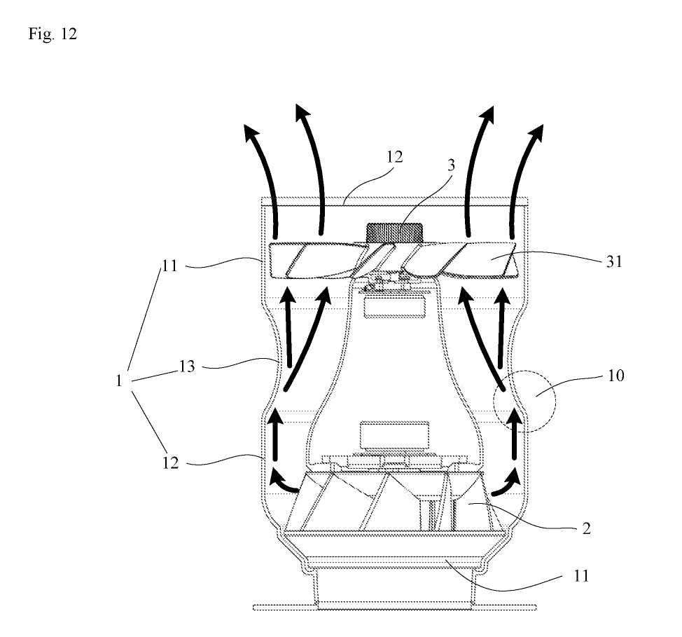

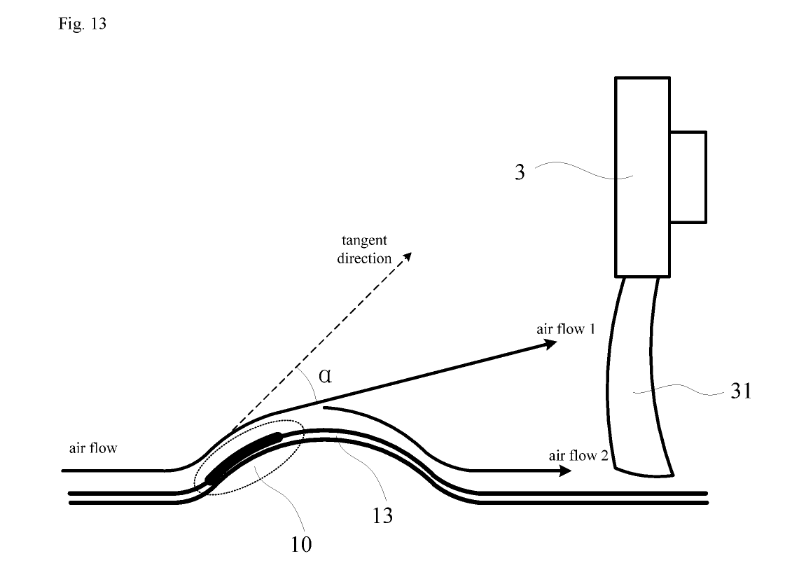

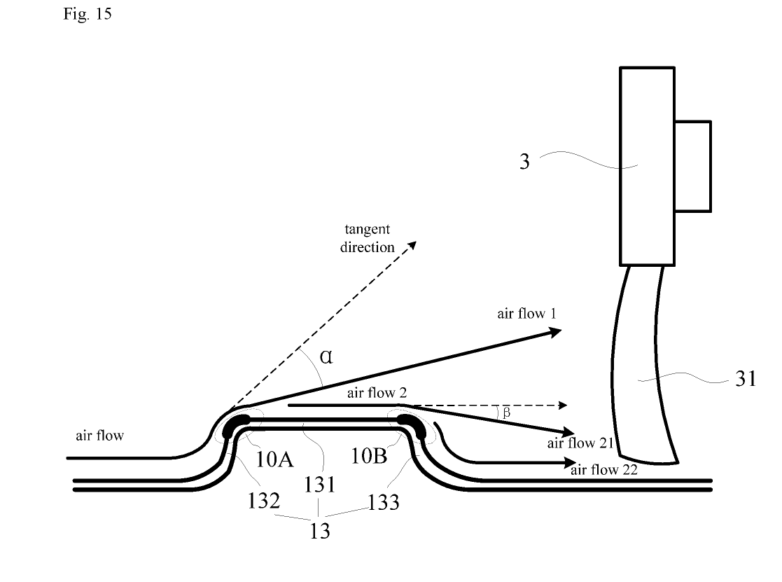

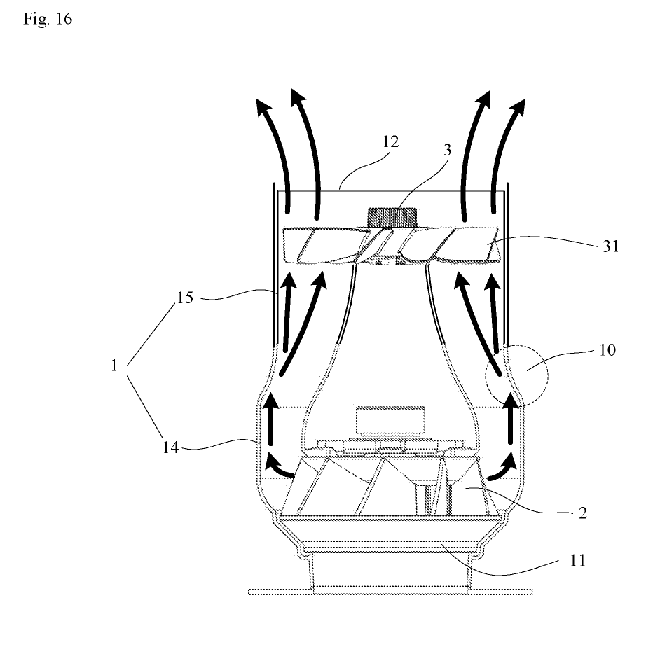

As another example, as shown in FIG. 7, the convex portion may have a boss shape. Taking a boss 100 shown in FIG. 7 as an example, the boss 100 may include a windward surface 100A facing the turbo fan 2 (In FIG. 7, the windward surface 100A is highlighted in a thick solid line, which is not intended to indicate that the windward surface 100A is more convex than other portions, and the same is applicable to FIG. 9, FIG. 11, FIG. 13 and FIG. 15). The windward surface 100A may be an arc-shaped surface which may generate a Coanda Effect when an air flow is blown towards the windward surface 100A, i.e., the air flow will not be bounced along a tangent direction of the windward surface 100A, or rather, the air flow may flow at least a certain distance along the windward surface 100A, such that a portion of the air flow, namely air flow 1, forms an angle a relative to the tangent direction of the windward surface 100A and is guided towards the middle of the blades 31 of the axial fan 3, while the other portion of the air flow, namely air flow 2, may continue to flow along the inner wall of the wind tunnel 1, to be blown towards the end portions of the blades 31 of the axial fan 3. In other words, the air flow generated by the turbo fan 2 is dispersed to individual portions of the blades 31 of the axial fan 3, so as to make full use of the acceleration generated from rotation of the blades 31 and thus acquire an greater wind guiding capacity and an improved purifying efficiency. Meanwhile, when the windward surface 100A is an arc-shaped surface, the arc-shaped surface may generate a smaller blocking effect on the air flow than the separation plate 102 as shown in FIG. 6. Therefore, as compared to the separation plate 102, the windward surface 100A of the boss 100 may have a less influence on the flowing rate of the air flow, so as to make full use of the acceleration by the turbo fan 2 on the air flow, resulting in a greater wind guiding capacity in a same condition and an improved air purifying effectiveness of the air purifier.

The boss 100 may have a plurality of structures. According to one embodiment, the boss 100 may be a boss 103 with an arc-shaped surface as shown in FIG. 8. Accordingly, in a schematic diagram of air-flow spoiling shown in FIG. 9, the boss 103 with the arc-shaped surface may include a windward surface 103A facing turbo fan 2, and the windward surface 103A may guide the air flow into an air flow 1 and an flow 2 fitted respectively for individual portions of the blades 31 of the axial fan 3, so as to make full use of the acceleration generated by the blades 31. According to another embodiment, the boss 100 may be a boss 104 shown as in FIG. 10. Accordingly, referring to the schematic diagram of the air flow spoiling shown in FIG. 11, the boss 104 includes a first edge 104A close to the turbo fan 2 and a second edge 104B away from the turbo fan 2, both the first edge 104A and the second edge 104B have an arc-shaped chamfer. Then, the first edge 104A having an arc-shaped chamfer forms a windward surface of the boss 104, and the windward surface guides the air flow into an air flow 1 and an air flow 2. The second edge 104B having an arc-shaped chamfer may also generate the Coanda Effect, such that the air flow 2 is further guided into an air flow 21 and an air flow 22 by the second edge 104B. Therefore, the air flow, after being guided for multiple times by the first edge 104A and the second edge 104B, may be fitted uniformly for individual portions of the blades 31, resulting in a greater wind guiding capacity, a higher purifying effectiveness and an improved purifying effect.

According to some embodiments of the disclosure, the wind tunnel 1 may include a normal pipe and a contracted pipe which has an inner diameter smaller than that of the normal pipe. The flow-spoiler portion 10 may include a windward surface facing the turbo fan 2, and the windward surface is formed in the contracted pipe close to the normal pipe and having an arc-shape so as to properly guide the air flow under the Coanda Effect.

According to an embodiment of the disclosure, the contracted pipe may be located between two normal pipes. As shown in FIG. 12, the wind tunnel 1 may include a first normal pipe 11, a second normal pipe 12 and a contracted pipe 13 which is located between the first normal pipe 11 and the second normal pipe 12. In the case that the first normal pipe 11 is closer to the axial fan 3 and the second normal pipe 12 is closer to the turbo fan 2, the flow-spoiler portion 10 may include a windward surface of contracted pipe 13 close to the second normal pipe 12. As shown in FIG. 13, the flow-spoiler portion 10 may generate the Coanda Effect on the air flow, so as to guide the air flow into an air flow 1 and an air flow 2 fitted respectively for individual portions of the blades 31.

According to embodiments shown in FIG. 12 to FIG. 13, an inner wall of the contracted pipe 13 has an inward convex arc-shaped surface. Therefore, the contracted pipe 13 shown in FIG. 12 to FIG. 13 may generate a similar flow-spoiler effect as the boss with the arc-shaped surface as shown in FIG. 8 to FIG. 9. The wind tunnel 1 shown in FIG. 8 to FIG. 9 has a uniform outer diameter, and the wind tunnel 1 shown in FIG. 11 to FIG. 12 has an outer diameter that varies at the contracted pipe 13.

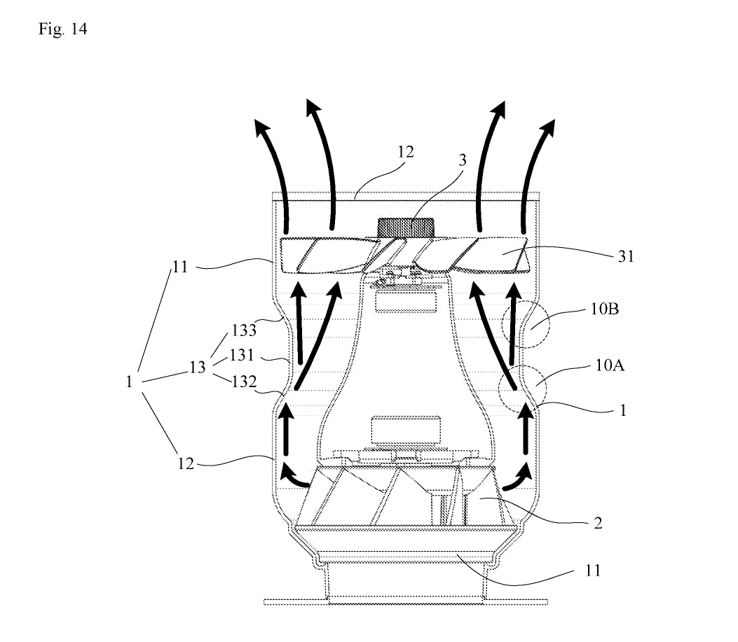

According to embodiments shown in FIG. 14 to FIG. 15, the contracted pipe 13 may include a cylinder 131 located at middle of the contracted pipe 13, the cylinder 131 has one outwardly extending flared end 132 connected to the second normal pipe 12 and another outwardly extending flared end 133 connected to the first the normal pipe 11. An edge 10A at connection of the cylinder 131 and the flared end 132 has an arc-shaped chamfer to form the windward surface, and an edge 10B at connection of cylinder 131 and the flared end 133 may also have an arc-shaped chamfer. Similar to the embodiments shown in FIG. 10 to FIG. 11, the edge 10A, as the windward surface, may guide the air flow from the turbo fan 2 into an air flow 1 and an air flow 2 under the Coanda Effect, and the edge 10B may further guide, under the Coanda Effect, the air flow 2 into an air flow 21 and an air flow 22 fitted respectively for individual portions of the blades 31.

According to another embodiment, the contracted pipe may be located at one side of the normal pipe, and an end of the contracted pipe forms a wind outlet 12. For example, as shown in FIG. 16, the normal pipe 14 may be located at the lower end of the wind tunnel 1, the contracted pipe 15 may be located at the upper end of the wind tunnel 1, and bottom of the contracted pipe 15 is connected to top of the normal pipe 14. Therefore, the flow-spoiler portion 10, which spoils the air flow generated by the turbo fan 2, may be formed at the bottom of the contracted pipe 15 close to the normal pipe 14.

Furthermore, in the embodiments shown in FIG. 4 to FIG. 16, a convex portion or deformation of the flow-spoiler portion 10 may change an inner diameter of the wind tunnel 1, such that the area of the wind tunnel 1 with a smaller inner diameter may spoil the air flow generated by the turbo fan 2 to be fully fitted for the blades 31 of the axial fan 3. As shown in FIG. 3, assuming that a diameter of the blades 31 of the axial fan 3 is T, and then a distance between an innermost side and an outermost side of the inner wall of the wind tunnel 1 may be t, and (⅙)T≤t≤(½)T. Of course, the disclosure is not intended to limit thereto.

Other embodiments of the disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A wind tunnel for an air purifier, the wind tunnel comprising:
a wind inlet;
a wind outlet;
a turbo fan arranged at the wind inlet for sucking into an air flow and blowing the air flow towards the wind outlet along an inner wall of the wind tunnel;
an axial fan arranged at the wind outlet for discharging the air flow; and
a flow-spoiler portion formed on the inner wall of the wind tunnel between the turbo fan and the axial fan, wherein the flow-spoiler portion spoils the air flow to make at least a portion of the air flow to be away from the inner wall of the wind tunnel when it is blown towards the axial fan.

2. The wind tunnel according to claim 1, wherein the flow-spoiler portion comprises an inward convex portion formed on the inner wall of the wind tunnel.

3. The wind tunnel according to claim 2, wherein the convex portion has an integral hollow-ring structure.

4. The wind tunnel according to claim 2, wherein the flow-spoiler portion comprises a plurality of convex portions distributed on the inner wall of the wind tunnel at intervals in a ring shape.

5. The wind tunnel according to claim 2, wherein the convex portion has a plate shape.

6. The wind tunnel according to claim 2, wherein the convex portion has a boss shape.

7. The wind tunnel according to claim 6, wherein the boss comprises a windward surface facing the turbo fan and having an arc shape.

8. The wind tunnel according to claim 7, wherein the boss is a boss which has an arc-shaped surface.

9. The wind tunnel according to claim 7, wherein the boss comprises a first edge close to the turbo fan and a second edge away from the turbo fan, and both the first edge and the second edge have an arc-shaped chamfer.

10. The wind tunnel according to claim 1, comprising:
a normal pipe;
a contracted pipe having an inner diameter smaller than that of the normal pipe;
wherein the flow-spoiler portion comprises a windward surface facing the turbo fan, and the windward surface being formed in the contracted pipe close to the normal pipe and having an arc-shape.

11. The wind tunnel according to claim 10, wherein the contracted pipe is arranged between two normal pipes.

12. The wind tunnel according to claim 11, wherein an inner wall of the contracted pipe has an inward convex arc-shaped surface.

13. The wind tunnel according to claim 11, wherein the contracted pipe comprises a cylinder located at middle of the contracted pipe, and the cylinder has two outwardly extending flared ends so as to connect to the normal pipes respectively;
wherein each of edges at connections of the cylinder and the flared ends has an arc-shaped chamfer; and
wherein the arc-shaped chamfer close to the turbo fan forms the windward surface, and the flow-spoiler portion further comprises an arc-shaped chamfer away from the turbo fan.

14. The wind tunnel according to claim 10, wherein the contracted pipe is located at one side of the normal pipe, and an end of the contracted pipe forms the wind outlet.

15. The wind tunnel according to claim 1, wherein the wind inlet is located at bottom of the wind tunnel, and the wind outlet is located at top of the wind tunnel; and
wherein the flow-spoiler portion is at a higher position than that of the turbo fan such that the air flow blown towards the axial fan, after flowing at least a preset distance along the inner wall of the wind tunnel, is spoiled by the flow-spoiler portion.

16. The wind tunnel according to claim 15, wherein a distance between a lowest point of the flow-spoiler portion and the turbo fan is ⅓ to ⅔ of a distance between the turbo fan and the axial fan.

17. The wind tunnel according to claim 1, wherein a distance between an innermost side and an outermost side of the inner wall of the wind tunnel is ⅙ to ½ of a diameter of the axial fan.

18. An air purifier, comprising:
a wind tunnel comprising:
a wind inlet;
a wind outlet;
a turbo fan arranged at the wind inlet for sucking into an air flow and blowing the air flow towards the wind outlet along an inner wall of the wind tunnel;
an axial fan arranged at the wind outlet for discharging the air flow; and
a flow-spoiler portion formed on the inner wall of the wind tunnel between the turbo fan and the axial fan, wherein the flow-spoiler portion spoils the air flow to make at least a portion of the air flow to be away from the inner wall of the wind tunnel when it is blown towards the axial fan.

19. The air purifier according to claim 18, wherein the flow-spoiler portion comprises an inward convex portion formed on the inner wall of the wind tunnel.

20. The air purifier according to claim 19, wherein the convex portion has an integral hollow-ring structure.
